(19) United States
(12) Patent Application Publication
(10) Pub. No.: US 2021/0155778 A1
(43) Pub. Date: May 27, 2021

(54) RUBBER COMPOSITION FOR COVERING STEEL CORD AND PNEUMATIC TIRE USING THE RUBBER COMPOSITION

(71) Applicant: Toyo Tire Corporation, Itami-shi (JP)

(72) Inventor: Takayoshi Kimura, Itami-shi (JP)

(73) Assignee: Toyo Tire Corporation, Itami-shi (JP)

(21) Appl. No.: 17/074,864

(22) Filed: Oct. 20, 2020

(30) Foreign Application Priority Data
Nov. 21, 2019 (JP) 2019-210784

(51) Int. Cl. C08L 7/00; C08K 3/06; C08K 5/3445; C08K 5/47; B60C 9/00

(52) U.S. Cl. CPC C08L 7/00; C08K 3/06; C08K 5/3445; C08K 2201/019; B60C 9/0007; B60C 2009/0021; C08K 5/47

(57) ABSTRACT

A rubber composition for covering a steel cord, that can improve wet heat adhesiveness while maintaining vulcanization rate is provided. The rubber composition for covering a steel cord comprises, per 100 parts by mass of a diene rubber, 1.0 to 5.0 parts by mass of an imidazole type age resister, and sulfur, wherein a sulfenamide type vulcanization accelerator is not contained, or even when contained, the amount of the sulfenamide type vulcanization accelerator is 1.5 parts by mass or less per 100 parts by mass of the diene rubber.

### TECHNICAL FIELD

The present invention relates to a rubber composition for covering a steel cord and a pneumatic tire using the rubber composition.

### BACKGROUND ART

Stable and strong adhesiveness, particularly wet heat adhesiveness, is required between a covering rubber and a metal reinforcing material in order that a metal reinforcing material-rubber composite in a belt layer or the like of a pneumatic tire exhibits high reinforcing effect and gains reliability. A so-called direct vulcanization adhesion of embedding a metal reinforcing material such as a steel cord plated with zinc, brass or the like in a covering rubber comprising natural rubber and sulfur added thereto and adhering those simultaneously with vulcanization of a rubber when heat vulcanizing is widely used as a method for obtaining a metal reinforcing material-rubber composite having stable and strong adhesion between a covering rubber and a metal reinforcing material.

A rubber composition for a covering rubber of a steel cord-rubber composite contains various age resisters. Of those, an amine type age resister has the effect of improving age properties such as oxidative degradation or heat resistance degradation and the effect of supplementing deterioration of anti-aging properties by the compounding of a diene synthetic rubber.

For example, Patent Literature 1 discloses that adhesiveness between a steel cord and a rubber composition for covering the steel cord is improved by adding predetermined amounts of an amine age register and a phenol age resistor to a rubber composition for covering a steel cord.

However, the amine age resister or the like interacts with cobalt (Co) or the like applied to a steel cord and affects adhesion performance to the steel cord. Therefore, there are the problems that the amine age resister or the like cannot be added in large amount and the small amount thereof added causes aging.

A sulfenamide type vulcanization accelerator is generally used as a vulcanization accelerator of a rubber composition for covering a steel cord. However, it is known that the sulfenamide type vulcanization accelerator releases an amine when vulcanizing, and the amine penetrates in a rubber-metal adhesion interface and accelerates intergranular stress corrosion cracking, thereby deteriorating wet heat adhesiveness. For this reason, the content of the sulfenamide type vulcanization accelerator is required to reduce, but there is a problem that vulcanization rate is insufficient by only reducing the content of the sulfenamide type vulcanization accelerator.

Patent Literature 1: JP-A 2014-156667

Patent Literature 2: JP-A 2014-162897

### SUMMARY OF INVENTION

In view of the above points, an object of the present invention is to provide a rubber composition for covering a steel cord, that can improve wet heat adhesiveness while maintaining vulcanization rate.

Patent Literature 2 discloses a method for producing a run flat tire which achieves both anti-aging properties and durability by adding a predetermined amount of zinc flower to a rubber composition when kneading a compound represented by the formula (1). Patent Literature 2 describes to use 2-mercaptobenzimidazole as a secondary age resister, but does not suggest that an imidazole type age resister has a vulcanization accelerating action and the content of a sulfenamide type vulcanization accelerator can be reduced by adding the imidazole type age resister.

A rubber composition for covering a steel cord according to the present invention comprises, per 100 parts by mass of a diene rubber, 1.0 to 5.0 parts by mass of an imidazole type age resister, and sulfur, wherein a sulfenamide type vulcanization accelerator is not contained, or even when contained, the amount of the sulfenamide type vulcanization accelerator is 1.5 parts by mass or less per 100 parts by mass of the diene rubber.

The sulfenamide type vulcanization accelerator comprises N,N-dicyclohexyl-2-tenzothiazole sulfenamide.

A pneumatic tire according to the present invention is manufactured using the rubber composition for covering a steel cord.

According to the rubber composition for covering a steel cord of the present invention, wet heat adhesiveness can be improved while maintaining vulcanization rate.

### DESCRIPTION OF EMBODIMENTS

Elements for carrying out the present invention are described in detail below.

The rubber composition for covering a steel cord according to the present embodiment comprises, per 100 parts by mass of a diene rubber, 1.0 to 5.0 parts by mass of an imidazole type age resister, and sulfur, wherein a sulfenamide type vulcanization accelerator is not contained, or even when contained, the amount of the sulfenamide type vulcanization accelerator is 1.5 parts by mass or less per 100 parts by mass of the diene rubber.

In the rubber composition according to the present embodiment, the diene rubber used as a rubber component includes, for example, natural rubber (NR), isoprene rubber (IR), butadiene rubber (BR), sryrene-butadiene rubber (SBR), styrene-isoprene copolymer rubber, butadiene-isoprene copolymer rubber, styrene-isoprene-butadiene copolymer rubber, acrylonitrile-butadiene rubber (NBR), chloroprene rubber (CR) and butyl rubber (IIR). Those diene rubbers can be used in one kind alone or as a blend of two or more kinds. The rubber component is preferably natural rubber, butadiene rubber, styrene-butadiene rubber or a blend of two or more kinds of those rubbers.

The rubber composition according to the present embodiment contains the imidazole type age resister, and the content thereof is not particularly limited so long as it is 1.0 to 5.0 parts by mass per 100 parts by mass of the diene rubber. The content is preferably 1.0 to 4.0 parts by mass and more preferably 1.0 to 3.0 parts by mass. When the content is within the above range, wet heat adhesiveness is easy to be improved while maintaining or improving vulcanization rate even in the case where the content of the sulfenamide type vulcanization accelerator has been reduced.

The imidazole type age resister includes 2-mercaptobenzimidazole, a zinc salt of 2-mercaptobenzimidazole, 2-mercaptomethylbenzimidazole, a zinc salt of 2-mercaptomethylimidazole and a zinc salt of 2-mercaptomethylimidazole.

In the rubber composition according to the present embodiment, a sulfenamide type, vulcanization accelerator is not contained, or when contained, the content of the sulfenamide type vulcanization accelerator is 1.5 parts by mass or less and preferably 1.0 part by mass or less, per 100 parts by mass of the diene rubber. When the sulfenamide type vulcanization accelerator is not contained or even when contained, if the content of the sulfenamide type vulcanization accelerator is within the above range, wet heat adhesiveness is easy to be improved.

The sulfenamide type vulcanization accelerator includes, for example, N-cyclohexyl-2-benzothiazole sulfenamide, N-t-butyl-2-benzothiazole sulfenamide, N-oxydiethyene-2-benzothiazole sulfenamide, N-oxydiethylene-2-benzothiazolyl sulfenamide, N,N-diisoproyl-2-benzothiazole sulfenamide and N,N-dicyclohexyl-2-benzothiazole sulfenamide.

In the rubber composition of the present embodiment, when the contents of the imidazole type age resister and the sulfenamide type vulcanization accelerator are within the above ranges, wet heat adhesiveness can be improved while maintaining vulcanization rate. The mechanism is not clear, but it can be presumed that by reducing the content of the sulfenamide type vulcanization accelerator, amine released during vulcanization is reduced and degradation of adhesion interface between the steel cord and the rubber composition for covering the steel cord can be suppressed; and by adding the imidazole type age resistor, the imidazole type age resister acts as a vulcanization accelerator and as a result, vulcanization rate can be maintained.

Reinforcing filler can be added to the rubber composition according to the present embodiment.

Carbon black and/or silica are preferably used as the reinforcing filler. In other words, the reinforcing filler may be carbon black alone, may be silica alone and may be a combination of carbon black and silica. Carbon black or a combination of carbon black and silica is preferred. The content of the reinforcing filler is not particularly limited, and, for example, is preferably 10 to 140 parts by mass, more preferably 20 to 100 parts by mass and still more preferably 30 to 80 parts by mass, per 100 parts by mass of the diene rubber.

The carbon black is not particularly limited, and the conventional various kinds can be used. The content of the carbon black is preferably 5 to 100 parts by mass and more preferably 20 to 80 parts by mass, per 100 parts by mass of the diene rubber.

The silica is not particularly limited, but wet silica such as wet precipitated silica or wet gelled silica is preferably used. When the silica is added, the content thereof is preferably 5 to 40 parts by mass and more preferably 5 to 30 parts by mass, per 100 parts by mass of the diene rubber.

Methylene receptor and methylene donor can be added to the rubber composition according to the present embodiment. By the reaction between a hydroxyl group of a methylene receptor and a methylene group of a methylene donor, adhesiveness between the rubber and the steel cord is enhanced, and degradation of adhesiveness due to load and heat generation due to tire running can be suppressed.

Phenol compound or phenol resin obtained by condensing the phenol compound with formaldehyde is used as the methylene receptor. The phenol compound includes phenol, resorcin and their alkyl derivatives. The alkyl derivatives include methyl group derivatives such as cresol and xylenol, and derivatives by a relatively long-chain alkyl group, such as nonyl phenol and octyl phenol. The phenol compound may contain an acyl group such as an acetyl group in a substituent.

The phenol resin obtained by condensing the phenol compound with formaldehyde includes a resorcin-formaldehyde resin, a phenol resin (that is, a phenol-formaldehyde resin), a cresol resin (that is, a cresol-formaldehyde resin), and a formaldehyde resin comprising a plurality of phenol compounds. Those resins are uncured resins, and liquid resins or resins having thermal fluidity are used.

Of those, from the standpoints of compatibility with the rubber component and other components, minuteness of the resin after curing, and reliability, resorcin or resorcin derivatives are preferred as the methylene receptor, and resorcin or a resorcin-alkyl phenol-formalin resin is particularly preferably used.

The content of those methylene receptors is not particularly limited, but is preferably 1 to 10 parts by mass and more preferably 1 to 4 parts by mass, per 100 parts by mass of the diene rubber.

Hexamethylenetetramine or a melamine derivative is used as the methylene donor. As the melamine derivative, methylolmelamine, a partially etherified product of methylolmelamine, a condensate of melamine, formaldehyde and methanol, or the like is used. Of those, hexamethoxymethylmelamine is particularly preferred.

The content of the methylene donor is not particularly limited, but is preferably 0.5 to 10 parts by mass and more preferably 0.5 to 4 parts by mass, per 100 parts by mass of the diene rubber.

Organic acid cobalt salt may be added as an adhesion improver with the steel cord to the rubber composition according to the present embodiment. The organic acid cobalt salt includes, for example, cobalt naphthenate, cobalt stearate, cobalt oleate, cobalt neodecanoate, cobalt rosinate, cobalt borate and cobalt maleate. Of those, cobalt naphthenate and cobalt stearate are particularly preferred from the standpoint of processability. The content of the organic acid cobalt salt is not particularly limited, but is preferably 0.03 to 0.50 parts by mass in terms of metal per 100 parts by mass of the diene rubber.

In addition to the components described above, compounding chemicals that are generally used in rubber industries, such as a process oil, zinc flower, stearic acid, a softener, a plasticizer, a wax, an age resister other than the imidazole type age resister, a vulcanizing agent and a vulcanization accelerator can be appropriately added within usual ranges to the rubber composition according to the present embodiment.

The vulcanizing agent includes sulfur components such as powdered sulfur, precipitated sulfur, colloidal sulfur, insoluble sulfur and highly dispersible sulfur. The content of the vulcanizing agent is not particularly limited, but is preferably 1 to 10 parts by mass and more preferably 2 to 8 parts by mass, per 100 parts by mass of the diene rubber. The content of the vulcanization accelerator is preferably 0 to 2 parts by mass and more preferably 0.2 to 1.0 part by mass, per 100 parts by mass of the diene rubber.

The age resister other than the imidazole type age resister includes an amine type age resister, a monophenol type age resister, a bisphenol type age resister, a polyphenol type age resister and a dithiocarbamate type age resister. In the case of containing the age resister other than the imidazole type age resister, the content thereof is not particularly limited, but is preferably 0.1 to 5 parts by mass and more preferably 0.5 to 3 parts by mass, per 100 parts by mass of the rubber component in the rubber composition.

The rubber composition according to the present embodiment can be prepared by kneading the necessary components according to the conventional method using a mixing machine generally used, such as Banbury mixer, a kneader or rolls.

The rubber composition according to the present embodiment is used as a covering (topping) rubber of a steel cord used as a reinforcing material in a belt layer or a carcass layer of a pneumatic tire. Specifically, the rubber composition is used as a rubber composition for covering a belt cord and/or a carcass cord. The rubber composition produces a steel cord topping texture by a topping apparatus such as a steel calender according to the conventional method. Unvulcanized tire is produced by using the steel cord topping texture as a belt layer and/or a carcass layer, and a pneumatic tire can be manufactured by vulcanization-molding the unvulcanized tire according to the conventional method.

The pneumatic tire may be a tire for passenger cars and may be a tire for heavy load, and is not particularly limited. The structure of the pneumatic tire is well known and is not particularly limited. In general, the pneumatic tire includes a pair of right and left bead parts, a pair of right and left sidewall parts, and a tread part provided between both sidewall parts so as to connect outer edges in a radial direction of the right and left sidewall parts, and includes at least one layer of a carcass layer extending across a pair of right and left bead parts. The carcass layer passes the sidewall part from the tread part, and both ends thereof are locked at the bead part, thereby reinforcing each part described above. Two or mere belt layers are generally provided between the tread rubbers in the outer peripheral side of the carcass layer in the tread part, and reinforce the tread part in the outer periphery of the carcass layer. In the present embodiment, when the rubber composition is used in the covering rubber of the steel cord, the rubber composition may be applied to any one of the belt layer and the carcass layer and may be applied to both layers.

### EXAMPLES

Examples of the present invention are described below, but the present invention is not construed as being limited to those examples.

Banbury mixer was used. Components excluding sulfur and a vulcanization accelerator were added according to the formulations (parts by mass) shown in Table 1 below, followed by mixing, in a first mixing step (discharge temperature: 160° C.). Sulfur and a vulcanization accelerator were then added to the resulting mixture, followed by mixing, in a final mixing step (discharge temperature: 90°C.). Thus, rubber compositions were prepared.

The details of each component in Table 1 are as follows.
Natural rubber: RSS #3
Carbon black: HAF, SEAST 300 manufactured by Tokai Carbon Co., Ltd.
Silica: NIPSIL AQ manufactured by Tosoh Silica Corporation
Zinc flower: Zinc Flower #3 manufactured by Mitsui Mining & Smelting Co., Ltd.
Resorcin derivative: Resorcin-alkyl phenol-formalin resin, SUMIKANOL 620 manufactured by Sumitomo Chemical Co., Ltd.
Melamine derivative: Hexamethoxymethyl melamine, CYLETS 963L manufactured by Mitsui Cytec Ltd.
Cobalt stearate: Cobalt Stearate (Co content 9.5 mass %) manufactured by Japan Energy Corporation
Age resister: SANTOFLEX 6PPD manufactured by Flexsys, amine type age resister
Imidazole type age resister: 2-Mercaptobenzimidazole, NOCRAC MB manufactured by Ouchi Shinko Chemical Industrial Co., Ltd.
Insoluble sulfur: CRYSTEC HS OT-20 (sulfur content 80 mass %) manufactured by Flexsys
Sulfenamide type vulcanization accelerator: N,N-dicyclohexyl-2-benzothiazole sulfenamide, NOCCELER DZ-G manufactured by Ouchi Shinko Chemical Industrial Co., Ltd,

Using each rubber composition obtained, unvulcanized samples of steel cord-rubber composites were prepared. In detail, steel cords for a bell (3×0.20+6×0.35 mm structure, copper/zinc=64/36 (mass ratio), brass plating in deposition amount of 5 g/kg) v/ere arranged in parallel in steel cord density of 12 numbers/25 mm, both surfaces of the arranged assembly were covered with a rubber sheet having a thickness of 1 mm comprising each rubber composition described above, and two assemblies were laminated such that the cords are parallel to each other. Thus, an unvulcanized sample for a peel adhesion test was prepared. Using the unvulcanized sample, scorch property, initial adhesiveness and wet heat adhesiveness were evaluated. Evaluation methods are as follows.
Scorch property: Scorch time t35 (min) under the condition of 125° C. was measured using L type rotor according to JIS K6300, and was indicated by an index as Comparative Example 1 being 100. Vulcanization rate is fast as the value is small. When the index is 80 to 100, it was evaluated that the vulcanization rate could be maintained.
Initial adhesiveness: The unvulcanized sample was prepared and allowed to stand at room temperature for 24 hours. The sample was vulcanized under the conditions of 150° C. and 30 minutes, and then subjected to a peel adhesion test using an autograph DCS500 manufactured by Shimadzu Corporation. Rubber coverage of the steel cord after peeling was visually observed and evaluated by 0 to 100%. The initial adhesiveness was indicated by an index as the rubber coverage of Comparative Example 1 being 100. The initial adhesiveness is excellent as the value is large.
Wet heat adhesiveness: The unvulcanized sample was allowed to stand at room temperature for 24 hours and then vulcanized under the conditions of 150° C. and 30 minutes. The vulcanized test piece was allowed to stand in a saturated steam at 105° C. for 96 hours, and then subjected to a peel test between the steel cords of two layers using an autograph DCS500 manufactured by Shimadzu Corporation. Rubber coverage of the steel cord after peeling was visually observed and evaluated by 0 to 100%. The wet heat adhesiveness was indicated by an index as the rubber coverage of Comparative Example 1 in the evaluation of initial adhesiveness being 100. The wet heat adhesiveness is excellent as the value is large.

TABLE 1

| | Com. | Com. | | | | |
|---|---|---|---|---|---|---|
| | Ex. 1 | Ex. 2 | Ex. 1 | Ex. 2 | Ex. 3 | Ex. 4 |
| Natural rubber | 100 | 100 | 100 | 100 | 100 | 100 |
| Carbon black | 60 | 60 | 60 | 60 | 60 | 60 |
| Silica | 10 | 10 | 10 | 10 | 10 | 10 |
| Zinc flower | 8 | 8 | 8 | 8 | 8 | 8 |
| Resorcin derivative | 2 | 2 | 2 | 2 | 2 | 2 |
| Melamine derivative | 2 | 2 | 2 | 2 | 2 | 2 |
| Cobalt stearate | 2 | 2 | 2 | 2 | 2 | 2 |
| [In terms of cobalt | [0.19] | [0.19] | [0.19] | [0.19] | [0.19] | [0.19] |
| metal] | | | | | | |
| Age resister | 2 | 1 | 1 | 1 | 1 | 1 |
| Imidazole type age | — | 0.5 | 2 | 2 | 1 | 3 |
| resister | | | | | | |
| Insoluble sulfur | 6 | 6 | 6 | 6 | 6 | 6 |
| Sulfenamide type | 0.5 | 0.3 | 0.3 | — | 0.3 | 0.3 |
| vulcanization | | | | | | |
| accelerator | | | | | | |
| Scorch property | 100 | 105 | 60 | 97 | 95 | 85 |
| Initial adhesiveness | 100 | 100 | 100 | 100 | 100 | 100 |
| Wet heat adhesiveness | 70 | 75 | 75 | 80 | 75 | 75 |

The results are shown in Table 1 above. It is understood from the comparison between Comparative Example 1 and Examples 1 to 4 that when a predetermined amount of the imidazole type age resister is added to the diene rubber, wet heat adhesiveness is improved while maintaining vulcanization rate even in case where the content of the sulfenamide type vulcanization accelerator has been decreased.

It is understood from the comparison between Comparative Example 1 and Comparative Example 2 that although wet heat adhesiveness is improved by decreasing the content of the sulfenamide type vulcanization accelerator. Comparative Example 2 is that the content of the imidazole type age resister is less than the predetermined amount, and therefore vulcanization rate is insufficient.

The rubber composition for covering a steel cord of the present invention is useful as a covering rubber of a steel cord that is a reinforcing material of a pneumatic tire, and a steel cord-rubber composite using the rubber composition can be used in a belt layer of a tire for passenger cars, a belt of a large-sized tires for trucks and buses, a carcass, a chafer layer, and the like.

What is claimed is:

1. A rubber composition for covering a steel cord, comprising, per 100 parts by mass of a diene rubber, 1.0 to 5.0 parts by mass of an imidazole type age resister, and sulfur,
wherein a sulfenamide type vulcanization accelerator is not contained, or even when contained, the amount of the sulfenamide type vulcanization accelerator is 1.5 parts by mass or less per 100 parts by mass of the diene rubber.

2. The rubber composition for covering a steel cord according to claim 1, wherein when the sulfenamide type vulcanization accelerator is contained, the sulfenamide type vulcanization accelerator comprises N,N-dicyclohexyl-2-benzothiazole sulfenamide.

3. A pneumatic tire manufactured using the rubber composition for covering a steel cord according to claim 1.

4. A pneumatic tire manufactured using the rubber composition for covering a steel cord according to claim 2.
